(19) United States
(12) Patent Application Publication
(10) Pub. No.: US 2025/0377044 A1
(43) Pub. Date: Dec. 11, 2025

(54) CLAMPING ASSEMBLY AND PROCESS VALVE

(71) Applicant: GEMÜ Gebr. Müller Apparatebau GmbH & Co. Kommanditgesellschaft, Ingelfingen (DE)

(72) Inventors: Klaus Frankenbach, Forchtenberg (DE); Simon Matter, Ravenstein (DE); Kai Sendner, Altenberg (DE)

(21) Appl. No.: 19/226,739

(22) Filed: Jun. 3, 2025

(30) Foreign Application Priority Data
Jun. 6, 2024 (DE) 10 2024 115 821.2

(51) Int. Cl. F16K 7/06

(52) U.S. Cl. CPC F16K 7/061

(57) ABSTRACT

A clamping assembly for a process valve includes a housing, a gear mechanism with a worm shaft and a rotatable clamping insert, and a clamping element configured to press a lateral outer collar of a valve diaphragm against a valve body. The worm shaft engages gear teeth on the clamping insert, which threads into the housing to convert rotational input into axial movement. Optional features include a drive mounting sleeve for securing a valve drive, a torque-limiting clutch, a predetermined breaking point, and self-locking threads to maintain clamping force and prevent over-torqueing. A process valve incorporating the clamping assembly is also disclosed.

### TECHNICAL FIELD

This disclosure relates generally to valve assemblies, and more particularly to clamping assemblies for process valves, such as diaphragm valves, that secure a valve diaphragm and a valve drive to a valve body.

### BACKGROUND

Process valves, including diaphragm valves, are widely used in fluid handling systems for controlling flow and isolating process media. These valves require reliable sealing between the valve diaphragm and the valve body to ensure leak-proof operation, particularly in applications involving corrosive, hazardous, or high-purity fluids.

Conventional clamping mechanisms for securing diaphragms in such valves often involve multi-part assemblies or require high actuation forces, which can complicate installation and maintenance. Furthermore, inadequate clamping or over-tightening can lead to diaphragm damage, sealing failure, or reduced component longevity.

### SUMMARY

The present disclosure provides a clamping assembly that addresses these issues through a gear-driven mechanism incorporating a worm shaft and a rotatable clamping insert. The insert translates rotational input into precise axial motion to securely clamp the outer collar of the valve diaphragm between a clamping element and the valve body. The assembly integrates self-locking thread geometries to maintain clamping force without back-driving, and may include safety features such as a torque-limiting clutch or predetermined breaking point to prevent damage from excessive torque. Additionally, a cylindrical drive mounting sleeve allows rigid, coaxial integration of the valve drive, further enhancing mechanical stability and reducing stress concentrations. This design improves serviceability, reduces required assembly force, and enhances the operational durability and safety of the process valve.

A first aspect of the description relates to a clamping assembly for a process valve, in particular a diaphragm valve, wherein the clamping assembly comprises: a housing with an interface for connection to a valve body; a gear mechanism supported on the housing, wherein the gear mechanism comprises a worm shaft mounted rotatably in the housing, wherein the gear mechanism comprises a clamping insert mounted in the housing so as to rotate about an adjustment axis, the worm gear teeth of said clamping insert being in engagement with the worm shaft, and wherein an external thread of the rotatable clamping insert is in engagement with an internal thread of the housing in order to move the clamping insert axially along the adjustment axis and relative to the housing by the rotation of said clamping insert; and a clamping element arranged on the output of the gear mechanism, wherein the clamping element comprises a pressing surface, which is designed to clamp a lateral outer collar of a valve diaphragm of the process valve between the clamping element and the valve body.

Advantageously, the valve diaphragm can be easily clamped using the proposed worm drive and the clamping insert that is axially movable in the housing. Advantageously, only a small actuating force is required for this purpose.

In one example, a cylindrical drive mounting sleeve for rigidly fixing a valve drive to the valve body extends from a side of the clamping assembly that faces the valve drive into the clamping assembly, wherein the cylindrical drive mounting sleeve comprises a through-opening running along the adjustment axis, for receiving the drive rod of the valve drive.

Advantageously, the drive rod is arranged at least in portions within the drive mounting sleeve. In addition, the drive rod can be guided axially through the drive mounting sleeve.

In one example, the clamping insert entrains an outer collar of the drive mounting sleeve during a movement along the adjustment axis in the direction of the valve body.

This ensures that the valve drive is rigidly fixed by means of the clamping insert.

In one example, an outer collar of the drive mounting sleeve is arranged at least in portions between the clamping insert and the clamping element.

This shifts the location of the connection between the valve body and the valve drive in the direction of the valve body. This is advantageous since the force path between the tensile stress on the housing of the clamping assembly and the compressive stress on the drive mounting sleeve and on the clamping element is shortened, which improves the fatigue strength of the connection during operation of the process valve.

In one example, a torque transmission portion of the worm shaft is accessible from outside the clamping assembly.

A technician can thus use a powered or non-powered hand tool to assemble and disassemble the process valve for diaphragm replacement. Disassembly and assembly are simplified by the accessible single torque transmission portion.

In one example, a predetermined breaking point is arranged between the torque transmission portion of the worm shaft and a worm flank portion of the worm shaft that is in engagement with the worm gear teeth of the clamping insert.

If the torque is excessive, the predetermined breaking point breaks and prevents destruction of the gear mechanism, the valve diaphragm, or other components of the process valve.

In one example, a safety clutch is arranged between the torque transmission portion of the worm shaft and the worm flank portion of the worm shaft that is in engagement with the worm gear teeth of the clamping insert.

The safety clutch effectively prevents the introduction of excessive torque since it opens and interrupts the torque transmission when a torque threshold value is exceeded. This effectively prevents damage to the clamping assembly.

In one example, the worm shaft is made of a metal alloy at least in the engagement region with the clamping insert and the clamping insert is made of a plastic at least in the engagement region with the worm shaft, or the clamping insert is made of a metal alloy at least in the engagement region with the worm shaft and the worm shaft is made of a plastic at least in the engagement region with the clamping insert.

This advantageously reduces the torque that is to be introduced into the worm shaft and is necessary for an axial movement of the clamping insert or for introducing the clamping force.

In one example, the worm gear teeth of the clamping insert are made of the plastic, wherein the external thread of the clamping insert is made of the metal alloy or another metal alloy.

This hybrid clamping insert makes it possible to reduce the torque that is to be introduced into the worm shaft and is necessary for clamping the valve diaphragm.

In one example, a worm drive comprising the clamping insert and the worm shaft is designed to be self-locking.

This advantageously prevents unintentional relaxation of the outer collar of the valve diaphragm.

In one example, the external thread of the clamping insert and the engaging internal thread of the housing are designed to be self-locking.

Advantageously, this not only effectively prevents unintentional relaxation of the outer collar of the valve diaphragm. Rather, the trapezoidal thread also rigidly fixes the valve drive to the valve body.

In one example, the clamping insert and the worm shaft are configured to perform a rotational movement of the clamping insert due to the engagement with the rotating worm shaft, wherein the clamping insert and the housing are configured to perform an axial movement relative to the housing along the adjustment axis through the rotational movement of the clamping insert and the engagement of the external thread of the clamping insert in the internal thread of the housing.

A further aspect of the description relates to a process valve comprising the valve drive; a valve body; and the clamping assembly according to the first aspect, wherein the clamping assembly is arranged between the valve drive and the valve body.

In one example, an axial movement of the clamping insert in the direction of the valve body rigidly connects the housing of the clamping assembly and the valve drive to the valve body in that the clamping insert exerts a tensile force on the valve body via the housing and the clamping insert causes a compressive force on the drive mounting sleeve and the valve body via the clamping element. Further details and embodiments of the disclosure can be found in the following description, by which embodiments of the disclosure are further described and explained.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 shows a process valve in a section along an adjustment axis;

FIG. 2 shows the process valve of FIG. 1 in a section perpendicular to the adjustment axis;

FIG. 3 shows the process valve in another section along the adjustment axis;

FIG. 4 shows a clamping insert in a perspective view;

FIG. 5 shows the clamping insert in a sectional view;

FIG. 6 shows an example of a worm shaft in a sectional view;

FIG. 7 shows another example of the worm shaft in a sectional view; and

FIG. 8 shows another example of the worm shaft in a sectional view.

### DETAILED DESCRIPTION

Aspects of the present disclosure relate to a clamping assembly for a process valve, such as a diaphragm valve, that provides precise, tool-assisted clamping of a valve diaphragm and rigid coupling of a valve drive to a valve body. The assembly includes a worm-driven clamping insert that translates rotational input into axial clamping force, enabling reliable sealing and mechanical retention. Design features such as self-locking threads, accessible torque input, and optional overload protection enhance safety, serviceability, and operational reliability.

As used herein, “adjustment axis” refers to the longitudinal axis along which the clamping insert moves relative to the housing to apply or release a clamping force. This axis typically aligns with the central axis of the process valve assembly.

As used herein, “clamping insert” refers to a rotatable component supported within the housing and operatively engaged with both a worm shaft and a threaded interface.

Rotation of the clamping insert causes axial movement along the adjustment axis to generate clamping force.

As used herein, “worm shaft” refers to a helically threaded shaft mounted for rotation about an axis transverse to the adjustment axis, and configured to engage worm gear teeth on the clamping insert to impart rotational motion.

As used herein, “self-locking” refers to a mechanical condition in which applied torque results in axial displacement that is maintained without continued torque input, and which resists reverse motion due to friction or geometric design.

As used herein, “valve drive” refers to an actuator assembly configured to move a drive rod axially to actuate a valve diaphragm, thereby controlling the open or closed state of the valve.

As used herein, “drive mounting sleeve” refers to a cylindrical coupling structure that rigidly connects the valve drive to the clamping assembly. It surrounds the drive rod and may include an outer collar that is mechanically engaged by the clamping insert.

As used herein, “clamping element” refers to a component positioned between the clamping insert and the valve body, including a pressing surface configured to compress an outer collar of the valve diaphragm against the valve body to provide a seal.

As used herein, “predetermined breaking point” refers to a structurally weakened region of the worm shaft configured to fail under excess torque, thereby protecting surrounding components from damage.

As used herein, “safety clutch” refers to a torque-limiting mechanism that interrupts torque transmission when a predefined threshold is exceeded, preventing mechanical overload.

As used herein, “valve diaphragm” refers to a flexible membrane configured to open or close fluid flow in response to axial actuation, typically positioned between a valve body and valve drive in a process valve.

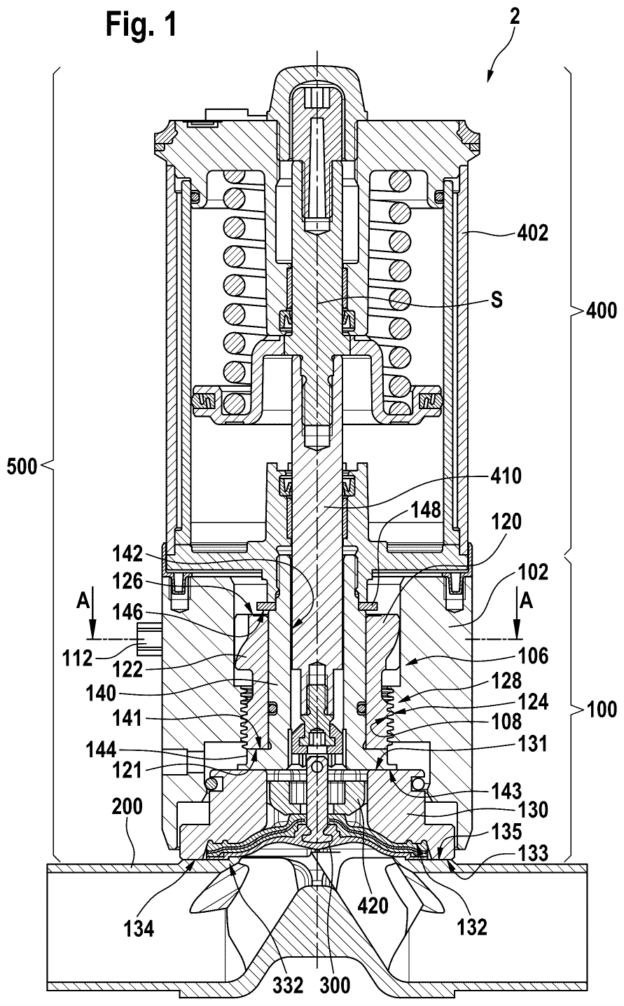

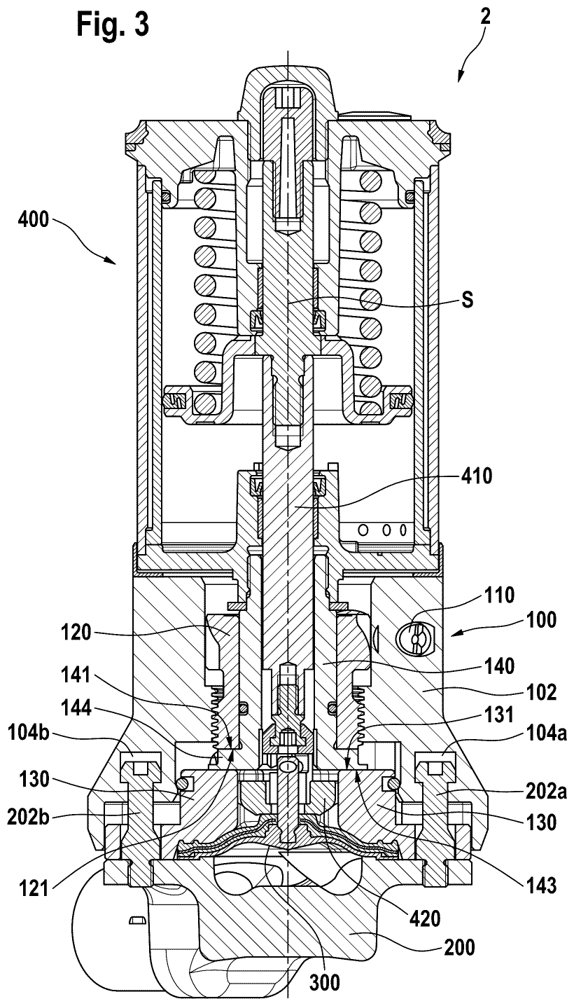

FIGS. 1 and 3 show a process valve 2, in particular a diaphragm valve, in a respective schematic section, in which an adjustment axis S of the process valve 2 lies. The process valve 2 comprises a valve drive 400, a valve body 200, and a clamping assembly 100 arranged between the valve drive 400 and the valve body 200.

The clamping assembly 100 comprises a housing 102 with an interface 104a-b for connection to the valve body 200.

A gear mechanism 106 of the clamping assembly 100 is supported on the housing 102. The gear mechanism 106 comprises a worm shaft 110 mounted rotatably in the housing 102. The gear mechanism 106 comprises a clamping insert 120 mounted in the housing 102 so as to rotate about the adjustment axis S, the worm gear teeth 122 of said clamping insert being in engagement with the worm shaft 110. An external thread 124 of the rotatable clamping insert 120 is in engagement with an internal thread 108 of the housing 102 in order to move the clamping insert 120 axially along the adjustment axis S and relative to the housing 102 by the rotation of the clamping insert 120.

A clamping element 130 arranged at the output of the gear mechanism 106 comprises a pressing surface 132 designed to clamp a lateral outer collar 332 of a valve diaphragm 300 of the process valve 2 between the clamping element 130 and the valve body 200.

It is provided in the example that the clamping insert 120 and the worm shaft 110 are configured to perform a rotational movement of the clamping insert 120 due to the engagement with the rotating worm shaft 110, and wherein the clamping insert 120 and the housing 102 are configured to perform an axial movement relative to the housing 102 along the adjustment axis S through the rotational movement of the clamping insert 120 and the engagement of the external thread 124 of the clamping insert 120 in the internal thread 108 of the housing 102.

A rotation axis N of the worm shaft 110 runs in a perpendicular plane of the adjustment axis.

The worm drive 116, which is provided by the connection of the worm shaft 110 and the clamping insert 120, the thread pair, which is provided by the thread 108 of the housing 102 and the thread 124 of the clamping insert 120, the bracing of the housing 102 on the valve body 200, and the clamping element 130 are configured such that an axial movement of the clamping insert 120 generates a clamping force between the outer collar 332 of the valve diaphragm 300 and the valve body 200, whereby the process valve 2 is sealed to the outside.

The worm drive 116, which is provided by the connection of the worm shaft 110 and the clamping insert 120, the thread pair, which is provided by the thread 108 of the housing 102 and the thread 124 of the clamping insert 120, the bracing of the housing 102 on the valve body 200, and the clamping element 130 are configured such that an axial movement of the clamping insert 120 generates a clamping force between a clamping surface 133 and a counter clamping surface 135 of the valve body 200, whereby the housing 102 of the clamping assembly 100 and the valve body 200 are rigidly fixed to each other.

The clamping element 130 is arranged between the outer collar 144 of the drive mounting sleeve 140 and the valve body 200.

The clamping element 130 is located between the clamping insert 120 and the valve body 200. The clamping element 130 can also be referred to as the clamping element 130 on the valve body side.

A worm drive 116 comprising the clamping insert 120 and the worm shaft 110 is designed to be self-locking. The worm drive 116 is self-locking since the angle of engagement between the worm shaft 110 and the clamping insert 120 is selected such that it enhances the self-locking properties of the worm drive 116.

The external thread 124 of the clamping insert 120 and the engaging internal thread 108 of the housing 102 are designed to be self-locking in order to maintain the set tension on the outer collar 332 of the valve diaphragm 300 without introducing any additional force into the gear mechanism 106.

In particular, the external thread 124 and the internal thread 108 are each designed as a trapezoidal thread.

The external thread 124 of the clamping insert 120 has one or more thread turns, wherein each thread turn has a trapezoidal cross-sectional shape defined by a first and a second flank, wherein the first flank forms a first angle to the axial direction of the screw spindle and the second flank forms a second, steeper angle to the axial direction of the clamping insert 120.

The internal thread 108 of the housing 102 is designed to engage in the external thread 124 of the clamping insert 120, wherein the internal thread 108 also has one or more thread turns with a trapezoidal cross-sectional shape that corresponds to the cross-sectional shape of the thread turns of the clamping insert 120.

The first angle and the second angle are designed such that they cause self-locking of the clamping insert 120 in the housing 102 by preventing the clamping insert 120 from being rotated without external force application.

With respect to the adjustment axis S, the clamping element 130 comprises, radially outside the pressing surface 132, a contact surface 134 for contacting a surface of the valve body 200. The contact surface 134 and the pressing surface 132 are spaced apart from each other perpendicularly to the adjustment axis S. This distance, together with the shape of the outer collar 332, determines the compression of the lateral outer collar 332 of the valve diaphragm 300.

The clamping element 130 is provided to divert the compressive force generated by the clamping insert 120, in the direction of the valve body 200. In addition, the clamping element 130 has a through-opening around the adjustment axis S in order to receive drive elements of the process valve. The compressive force introduced from the clamping insert 120 via a force transmission surface 131 radially inside with respect to the adjustment axis S is introduced on the one hand into the outer collar 332 of the valve diaphragm 300 and on the other hand via the contact surface 134 directly into the valve body 200.

In an example not shown, the valve diaphragm 300 projects from the clamped outer collar of the valve diaphragm 300 into a chamber, which is delimited at least in portions by the valve body 200 and by the clamping element 130. In this chamber, the valve diaphragm 300 is not clamped. This portion of the valve diaphragm 300 that projects from the clamped outer collar of the valve diaphragm 300 can also be referred to as a diaphragm tab.

In another example not shown, the valve diaphragm 300 is clamped between the housing 102 or the valve drive 400 and the valve body 200.

In the example shown, the clamping element 130 is clamped between the drive mounting sleeve 140 and the valve body 200 by means of the clamping insert 120.

It is provided that a cylindrical drive mounting sleeve 140 for rigidly fixing a valve drive 400 to the valve body 200 extends from a side of the clamping assembly 100 that faces the valve drive 400 into the clamping assembly 100, wherein the cylindrical drive mounting sleeve 140 comprises a through-opening 142 running along the adjustment axis S, for receiving a drive rod 410 of the valve drive 400.

Rotating the worm shaft 110 causes the clamping insert 120 to entrain an outer collar 144 of the drive mounting sleeve 140 during a movement along the adjustment axis S in the direction of the valve body 200.

Furthermore, it is provided that an outer collar 144 of the drive mounting sleeve 140 is arranged at least in portions between the clamping insert 120 and the clamping element 130.

A drive housing 402 of the valve drive 400 is rigidly connected to the drive mounting sleeve 140, wherein the drive rod 410 of the valve drive 400 is arranged axially movably in the through-opening 142 of the drive mounting sleeve 140.

A pressure piece 420 is connected to the drive rod 410 during operation of the process valve 2. The pressure piece 420 is axially guided along the adjustment axis S in the at least one clamping element 130 in a rotation-proof manner, i.e., substantially not rotatably about the adjustment axis S. The pressure piece 420 presses the valve diaphragm 300 onto the valve seat to seal the valve.

An axial movement of the clamping insert 120 in the direction of the valve body 200 rigidly connects the housing 102 of the clamping assembly 100 and the valve drive 400 to the valve body 200 in that the clamping insert 120 exerts a tensile force on the valve body 200 via the housing 102 and the clamping insert 120 causes a compressive force on the drive mounting sleeve 140 and the valve body 200 via the clamping element 130.

Multiple clamping bolts 202a-b, shown in FIG. 3, projecting from the valve body 200 engage with a respective head in corresponding bayonet grooves according to the interface 104a-b of the housing 102 of the clamping assembly 100, wherein the bayonet grooves according to the interface 104a-b are designed such that they make a positive connection by relative rotation between the housing 102 of the clamping assembly 100 and the valve body 200 possible.

Given the positive connection between the housing 102 of the clamping assembly 100 and the valve body 200, the clamping insert 120 supported on the housing 102 of the clamping assembly 100 is movable axially in the direction of the valve body 200, wherein the clamping insert 120 presses on the clamping element 130 during this movement in order to press the lateral outer collar 332 of the valve diaphragm 300 against the valve body 200.

In other words, a clamping force applied by the clamping insert 120 supported on the housing 102 of the clamping assembly 100 is transmitted via the clamping element 130 to the valve body 200 and the positive connection of the bayonet grooves according to the interface 104a-b causes a force transmission from the clamping bolts 202a-b to the housing 102 of the clamping assembly 100 so that the housing 102 of the clamping assembly 100, in particular also the valve drive 400, is rigidly fixed to the valve body 200 by the combined effect of the axial clamping force of the clamping insert 120 and the bracing of the housing 102 of the clamping assembly 100 by engaging in the clamping bolts 202a-b of the valve body 200.

The drive mounting sleeve 140 is rigidly connected to the valve drive 400. The housing 102 and the valve drive 400 are rotatable relative to each other in the arrangement shown. In another example, the housing 102 and the valve drive 400 are not rotatable relative to each other due to interlocking contours.

The rotatable clamping insert 120 has a force transmission surface 121 on the valve body side, which force transmission surface rests on the force transmission surface 141 of the drive mounting sleeve 140 in order to transmit the compressive force via the drive mounting sleeve 140 to the clamping element 130.

In an example not shown, a bearing is arranged between the force transmission surfaces 121 and 141 and reduces the friction losses in comparison to surfaces resting directly on one another.

A force transmission surface 143 of the drive mounting sleeve 140 presses the force transmission surface 131 of the clamping element 130 in order to clamp the outer collar 332 of the valve diaphragm 300.

The clamping element 130 is non-rotatable relative to the housing 102 of the clamping assembly 100 in order to prevent the introduction of rotationally induced shear forces into the valve diaphragm 300. For example, a projection of the clamping element 130 engages for this purpose in a groove that is made in the housing and parallel to the adjustment axis S.

In an example not shown, the drive mounting sleeve 140 is either not present or engages the clamping insert 120 at a different location. As an alternative to providing the drive mounting sleeve 140, it can be provided, for example, that the valve drive is fixed in another way, for example by a screw connection or other type of mounting to the clamping assembly 100.

A stop surface 146 fixed to the drive mounting sleeve 140 forms a stop for a stop surface 128 of the clamping insert 120 that faces away from the valve body 200.

The stop surface 146 is provided by a ring 148 fixed between the drive housing 402 and the drive mounting sleeve 140.

The axial movement of the clamping insert 120 of the clamping assembly 100 in the direction of the valve body 200, i.e., in a clamping direction, rigidly connects the housing 102 of the clamping assembly 100 and the valve drive 400 to the valve body 200 in that the clamping insert 120 supported on the housing 102 of the clamping assembly 100 causes a tensile force on the valve body 200 via the housing 102 and a connection of the housing 102 to the valve body 200 and in that the clamping insert 120 supported on the housing 102 causes a compressive force on the outer collar 332 of the valve diaphragm 300 via the clamping element 130.

The axial movement of the clamping insert 120 of the clamping assembly 100 in the direction of the valve body 200, i.e., in the clamping direction, rigidly connects the housing 102 of the clamping assembly 100 and the valve drive 400 to the valve body 200 in that the clamping insert 120 supported on the housing 102 of the clamping assembly 100 causes a tensile force on the valve body 200 via the housing 102 and a connection of the housing 102 to the valve body 200 and in that the clamping insert 120 supported on the housing 102 causes a compressive force via the clamping element 130 on the drive mounting sleeve 140 connected rigidly to the valve drive 400 and on the valve body 200.

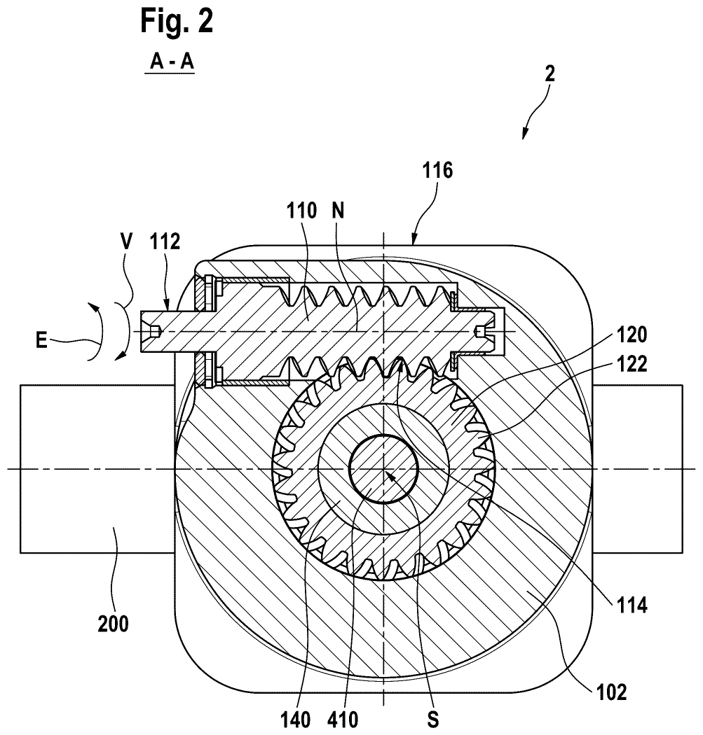

FIG. 2 shows the process valve 2 in a section perpendicular to the adjustment axis S. A torque transmission portion 112 of the worm shaft 110 is accessible from outside the clamping assembly 100.

The clamping insert 120 is arranged between the drive mounting sleeve 140 and the housing 102, at least in the section perpendicular to the adjustment axis S shown in FIG. 2.

The clamping insert 120 is mounted on the drive mounting sleeve 140 so as to rotate about the adjustment axis S.

The drive mounting sleeve 140 is arranged between the drive rod 410 and the clamping insert 120, at least in the section perpendicular to the adjustment axis S shown in FIG. 2.

The drive rod 410 is mounted in the drive mounting sleeve 140 so as to move along the adjustment axis S.

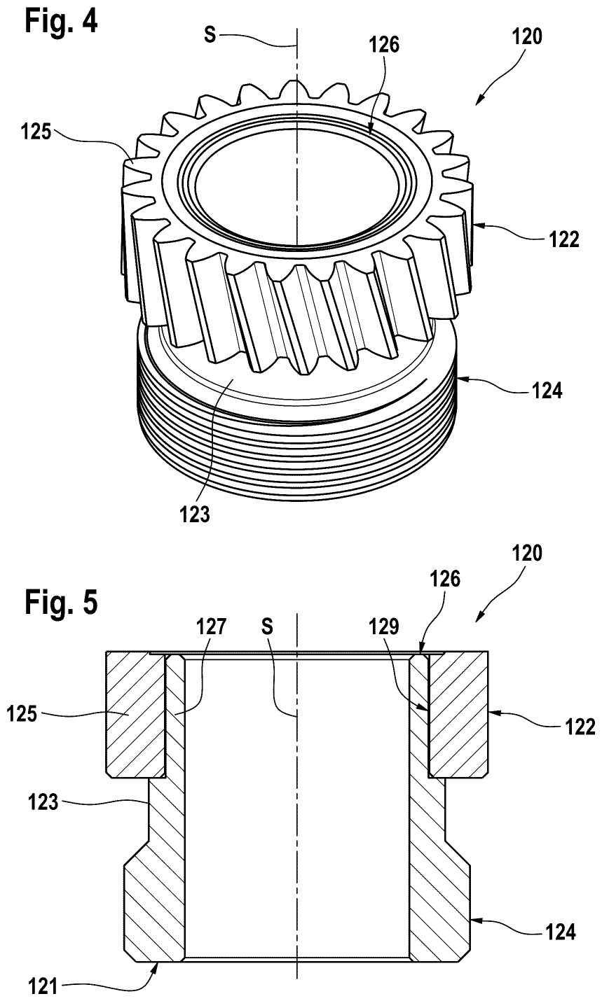

FIGS. 4 and 5 show an example of the clamping insert 120 comprising a first portion 123 and a second portion 125. The first portion 123 provides the external thread 124, which is designed, for example, as a trapezoidal thread, and a connecting region 127 for connection to the second portion 125. The second portion 125 provides the worm gear teeth 122 and is non-positively connected via its through-opening 129 to the connecting region 127. The second portion 125 is pressed onto the first portion 125.

For example, it is provided that the worm shaft 110 is made of a metal alloy at least in the engagement region with the clamping insert 120 and the clamping insert 120 is made of a plastic at least in the engagement region with the worm shaft 110

In the example shown, it is provided that the worm gear teeth 122 of the clamping insert 120 are made of the plastic, wherein the external thread 124 of the clamping insert 120 is made of a metal alloy such as stainless steel or another metal alloy.

In an example not shown, the clamping insert 120 is made of a metal alloy at least in the engagement region with the worm shaft 110 and the worm shaft 110 is made of a plastic at least in the engagement region with the clamping insert 120.

The plastic comprises, for example, at least one of the following plastics: polyamide (PA), polyoxymethylene (POM), polyetheretherketone (PEEK), a fluoroplastic such as polytetrafluoroethylene (PTFE), a polyimide such as polyetherimide (PEI), a sulfide polymer such as polyphenylene sulfide (PPS).

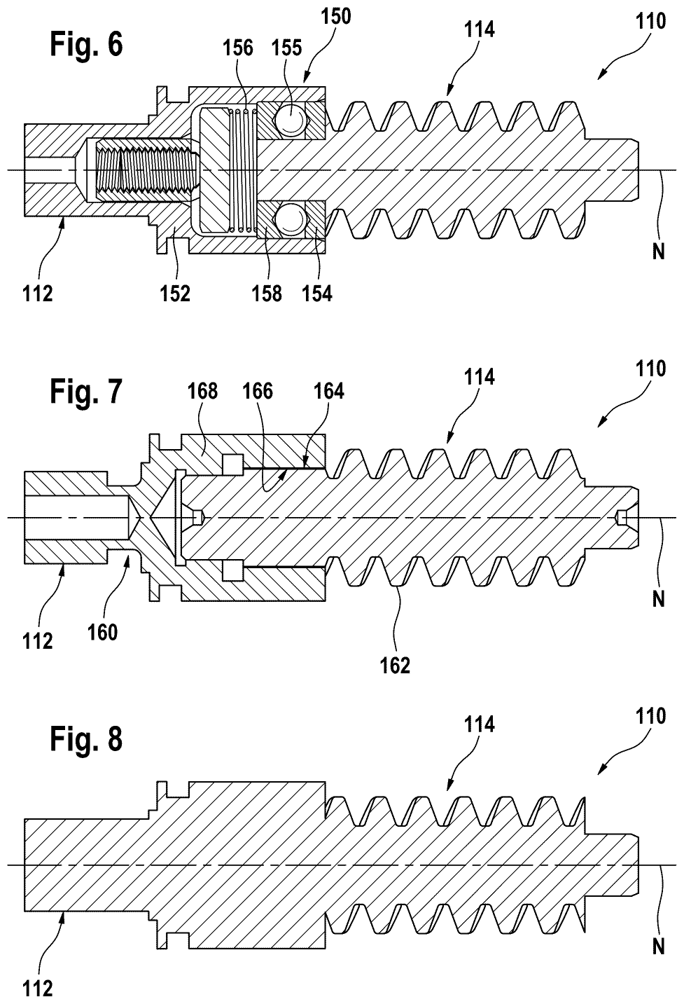

In the example of the worm shaft 110 shown in FIG. 6, it is provided that a safety clutch 150, which can also be referred to as a slip clutch, is arranged between the torque transmission portion 112 of the worm shaft 110 and the worm flank portion 114 of the worm shaft 110 that is in engagement with the worm gear teeth 122 of the clamping insert 120.

The safety clutch 150 serves to transmit a torque between a torque transmission portion 112 and a worm flank portion 114. The safety clutch 150 comprises a first clutch component 152, which is fixedly connected to the torque transmission portion 112, and a second clutch component 154, which is fixedly connected to the worm flank portion 114. The first and second clutch components 152, 154 are arranged to be movable relative to each other.

The safety clutch 150 further comprises a spring arrangement 156, which is configured to generate a preload force between the first clutch component 152 and the second clutch component 154, thereby making backlash-free torque transmission possible. This transmission is carried out by means of multiple balls 155, which are arranged in depressions on an end face of the first clutch component 152 and are pressed into the depressions by the spring arrangement 156 through a spring-loaded switching ring 158.

In the event of an overload, when the torque transmitted via the safety clutch 150 exceeds a preset release torque, the conical shape of the depressions makes it possible for the balls to be lifted out against the pressing force of the spring arrangement 156. This results in the input and output sides being separated without torque.

The safety clutch 150 thus comprises a freewheel device, which comprises the spring arrangement 156, the switching ring 158, the balls 155, and the depressions in the second clutch component 154. This freewheel device is designed to interrupt torque transmission when a threshold value of the force is exceeded. This is achieved by making relative rotation between the first and second clutch components 152, 154 possible.

In one example, the safety clutch 150 opens in a clamping rotational direction V for clamping the outer collar 332 of the valve diaphragm 300 from a first torque threshold value, wherein the safety clutch 150 opens in a relaxing rotational direction E for relaxing the outer collar 332 of the valve diaphragm 300 from a second torque threshold value, wherein the second torque threshold value is greater, in particular at least 5% greater, in particular at least 10% greater, in particular at least 25% greater, than the first torque threshold value.

Advantageously, the valve diaphragm can be safely relaxed again by the safety clutch 150 designed with different torque threshold values, and a state in which the clamping of the valve diaphragm can no longer be released is safely prevented by the safety clutch 150 configured in this way.

In the example shown in FIG. 7, it is provided that a predetermined breaking point 160 is arranged between the torque transmission portion 112 of the worm shaft 110 and a worm flank portion 114 of the worm shaft 110 that is in engagement with the worm gear teeth 122 of the clamping insert 120. In the example, the predetermined breaking point 160 is realized by a tapered material portion, which transmits the torque introduced into the worm shaft 110 via the torque transmission portion 112, in the direction of the worm flank portion 114.

In order to continue using the process valve after the predetermined breaking point 160 has been broken, a first portion 162 of the worm shaft 110, which portion comprises the worm flank portion 114, is provided with an outer contour 164, which engages in an inner contour 166 of a second portion 168 in a torque-transmitting manner. The torque transmission from the second portion 168 to the first portion 162 is thus realized via a positive connection between a two-flat, hexagon, or the like. The second portion 168 comprises the torque transmission portion 112 and the predetermined breaking point 160.

FIG. 8 shows an example of a one-piece worm shaft 110.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure. Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A clamping assembly for a process valve, comprising:
a housing having an interface configured for connection to a valve body;
a gear mechanism supported on the housing, the gear mechanism comprising:
a worm shaft mounted rotatably in the housing; and
a clamping insert mounted in the housing so as to rotate about an adjustment axis, the clamping insert having worm gear teeth in engagement with the worm shaft,
wherein the clamping insert includes an external thread in engagement with an internal thread of the housing, such that rotation of the clamping insert causes axial movement along the adjustment axis relative to the housing; and
at least one clamping element arranged at an output side of the gear mechanism, the clamping element including a pressing surface configured to clamp a lateral outer collar of a valve diaphragm between the clamping element and the valve body.

2. The clamping assembly of claim 1, wherein a cylindrical drive mounting sleeve extends from a side of the clamping assembly that faces a valve drive into the clamping assembly, the drive mounting sleeve being configured to rigidly fix the valve drive to the valve body, and wherein the drive mounting sleeve comprises a through-opening extending along the adjustment axis for receiving a drive rod of the valve drive.

3. The clamping assembly of claim 2, wherein the clamping insert is configured to entrain an outer collar of the drive mounting sleeve during axial movement of the clamping insert in the direction of the valve body.

4. The clamping assembly of claim 2, wherein an outer collar of the drive mounting sleeve is at least partially positioned between the clamping insert and the at least one clamping element.

5. The clamping assembly of claim 1, wherein a torque transmission portion of the worm shaft is accessible from outside the clamping assembly.

6. The clamping assembly of claim 5, further comprising a predetermined breaking point located between the torque transmission portion of the worm shaft and a worm flank portion of the worm shaft that engages with the worm gear teeth of the clamping insert.

7. The clamping assembly of claim 1, further comprising a safety clutch arranged between a torque transmission portion of the worm shaft and a worm flank portion of the worm shaft that engages with the worm gear teeth of the clamping insert.

8. The clamping assembly of claim 1, wherein the worm shaft is made of a metal alloy at least in the region engaging the clamping insert, and the clamping insert is made of a plastic at least in the region engaging the worm shaft

9. The clamping assembly of claim 1, wherein the clamping insert is made of a metal alloy at least in the region engaging the worm shaft, and the worm shaft is made of a plastic at least in the region engaging the clamping insert.

10. The clamping assembly of claim 8, wherein the worm gear teeth of the clamping insert are made of the plastic, and the external thread of the clamping insert is made of the metal alloy or a different metal alloy.

11. The clamping assembly of claim 1, wherein a worm drive comprising the clamping insert and the worm shaft is configured to be self-locking.

12. The clamping assembly of claim 1, wherein a thread pair comprising the external thread of the clamping insert and the internal thread of the housing is configured to be self-locking.

13. The clamping assembly of claim 1, wherein:
the clamping insert and the worm shaft are configured such that rotation of the worm shaft causes rotation of the clamping insert; and
the clamping insert and the housing are configured such that rotation of the clamping insert causes axial movement of the clamping insert along the adjustment axis relative to the housing.

14. A process valve comprising:
a valve drive;
a valve body;
a valve diaphragm clamped between the valve body and the valve drive; and
a clamping assembly according to claim 1, wherein the clamping assembly is arranged between the valve drive and the valve body.

15. The process valve of claim 14, wherein axial movement of the clamping insert in the direction of the valve body rigidly connects the housing of the clamping assembly and the valve drive to the valve body, such that:
the clamping insert exerts a tensile force on the valve body via the housing; and
the clamping insert causes a compressive force on the outer collar of the valve diaphragm via the clamping element.

16. The process valve of claim 14, wherein axial movement of the clamping insert in the direction of the valve body rigidly connects the housing of the clamping assembly and the valve drive to the valve body, such that:
the clamping insert exerts a tensile force on the valve body via the housing; and
the clamping insert causes a compressive force via the clamping element on the drive mounting sleeve rigidly connected to the valve drive and on the valve body.
